(19) United States
(12) Patent Application Publication
(10) Pub. No.: US 2009/0094253 A1
(43) Pub. Date: Apr. 9, 2009

(54) CONTENT DELIVERY SYSTEM, DELIVERY SERVER, USER TERMINAL, AND METHOD

(76) Inventor: Tomoyuki HANAI, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/174,468

(22) Filed: Jul. 16, 2008

(30) Foreign Application Priority Data
Jul. 18, 2007 (JP) 2007-187661

(51) Int. Cl. G06F 17/30

(52) U.S. Cl. 707/10; 707/E17.01

(57) ABSTRACT

A system including a delivery server and a user terminal is disclosed. The deliver server includes a processor configured to transmit metadata including schedule information about release dates for content items, receive a request for one of the content items, the request being based on the schedule information included in the metadata, and transmit the requested content item in response to the request. The user terminal includes a processor configured to receive the metadata including the schedule information about release dates for the content items, send the request for one of the content items based on the schedule information included in the metadata, and receive the requested content item.

### BACKGROUND OF THE INVENTION

The present invention relates to a content delivery system, a delivery server, a user terminal, and a method.

Recent years have witnessed the growth of content delivery services for delivering content items consisting of computer data to users. Examples of content items include movies, songs, sports events, and computer software. Content items may be delivered to users over networks such as the Internet.

A content delivery service may include a delivery server and a plurality of user terminals all connected to a network. The delivery server stores a plurality of content items. When accessed by one of the user terminals requesting a content item, the server may deliver the requested content item to the user terminal. Each user terminal accesses the delivery server over the network to receive (i.e., download) content items of interest to the user of the user terminal. For example, a user may operate his or her user terminal to access the delivery server before downloading desired content items from the delivery server.

A TV series such as a drama may include a plurality of episodes. Each of the episodes may correspond to one or more content items, or be spread across several content items. In some circumstances, not all content items for a given series may be initially available for download. In this circumstance, users are unable to download all of the content items for the series all at once.

It may also be burdensome to store all of the content items constituting a series at the same time. A delivery server may need to possess an inordinately large storage capacity to accommodate all of the content items for a TV series. Furthermore, users accessing the delivery server to download content items may exceed the network capacity. When a large number of users are downloading multiple content items simultaneously, the download times may be adversely affected.

One way to reduce the number of content items that need to be stored on the delivery server is to stagger the points in time at which the content items are available for download. This measure prompts users to access the server in dispersed fashion. One disadvantage of this measure is that each user download each of the content items individually as they become available. Users may also be unaware that a given content item has been made available for download, and may even wait so long that the content item becomes unavailable again.

### SUMMARY OF THE INVENTION

Consistent with certain embodiments of the invention, systems and methods are provided for enabling users to receive content items without missing their release dates. The methods may be suitable for execution by a computerized or software-based system.

A system is provided comprising a delivery server comprising a processor and a user terminal comprising a processor. The delivery server processor is configured to transmit metadata including schedule information about release dates for content items; receive a request for one of the content items, the request being based on the schedule information included in the metadata; and transmit the requested content item in response to the request. The user terminal processor is configured to receive the metadata including the schedule information about release dates for the content items; send the request for one of the content items based on the schedule information included in the metadata; and receive the requested content item.

A delivery server is provided comprising a processor configured to transmit metadata including schedule information about release dates for content items; receive a request for one of the content items, the request being based on the schedule information included in the metadata; and transmit the requested content item in response to the request.

A user terminal is provided comprising a processor configured to receive metadata including schedule information about release dates for content items; send a request for one of the content items based on the schedule information included in the metadata; and receive the requested content item.

A computer-readable medium is provided containing processor readable instructions for causing a computer to execute a method, the method comprising transmitting metadata including schedule information about release dates for content items; receiving a request for one of the content items, the request being based on the schedule information included in the metadata; and transmitting the requested content item in response to the request.

A computer-readable medium is provided containing processor readable instructions for causing a computer to execute a method, the method comprising receiving metadata including schedule information about release dates for content items; sending a request for one of the content items based on the schedule information included in the metadata; and receiving the requested content item.

A computer-implemented method is provided, comprising transmitting metadata including schedule information about release dates for content items; receiving a request for one of the content items, the request being based on the schedule information included in the metadata; and transmitting the requested content item in response to the request.

A computer-implemented method is provided, comprising receiving metadata including schedule information about release dates for content items; sending a request for one of the content items based on the schedule information included in the metadata; and receiving the requested content item.

It is to be understood that both the foregoing general description and the following detailed description are exemplary and explanatory only and are not restrictive of the invention or embodiments thereof, as claimed.

### BRIEF DESCRIPTION OF THE DRAWINGS

FIG. 1 is a schematic illustration of a content delivery system.

FIG. 2 is an illustration of a user terminal.

FIG. 3 is an illustration of a file.

FIG. 4A is a flow chart of a method.

FIG. 4B is a flow chart of a method.

FIG. 5A is an illustration of a download sequence.

FIG. 5B is an illustration of a download sequence.

FIG. 5C is an illustration of a download sequence.

FIG. 6A is an illustration of content management.

FIG. 6B is an illustration of content management.

FIG. 7 is an illustration of content management.

FIG. 8A is an illustration of a system.

FIG. 8B is an illustration of a system.

FIG. 9A is an illustration of a display.

FIG. 9B is an illustration of a display.

FIG. 9C is an illustration of a display.

### DETAILED DESCRIPTION

Preferred embodiments of the present invention will now be described in detail with reference to the accompanying drawings. Throughout the drawings and the descriptions that follow, like or corresponding parts in terms of function and structure will be designated by like reference numerals, and their explanations will be omitted where redundant.

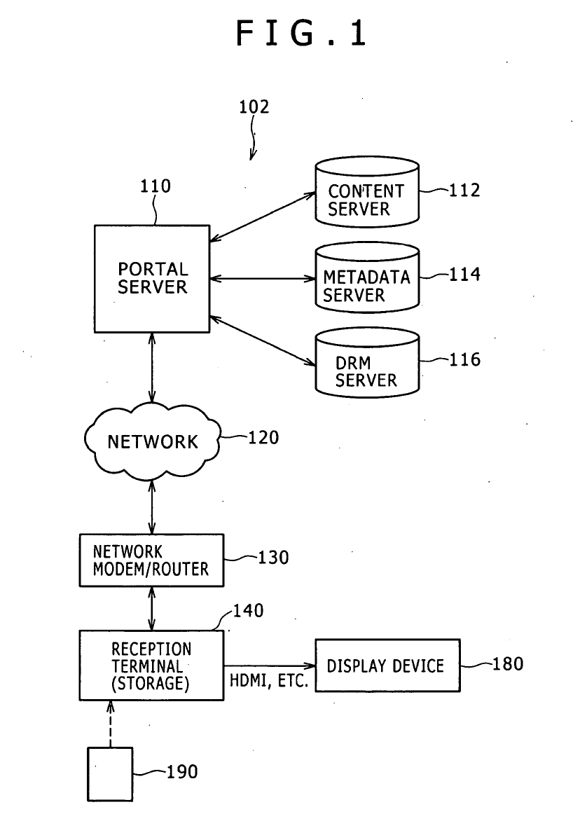

FIG. 1 illustrates a typical configuration of a content delivery system 100. Content delivery system 100 delivers computer data in the form of content items such as movies, songs, and sports events over networks such as the Internet. System 100 includes a delivery server 102 and a user terminal 140 connected via a network 120. Network 120 may be a WAN such as the Internet, a LAN, a wired or wireless network, or any other network suitable for communicating data between computers. Network 120 may also be a combination of these types of networks. Content delivery system 100 may perform a content delivery service that allows delivery server 102 to deliver content items to user terminal 140 and enables user terminal 140 to download the content items.

Network 120 may be a wide-area IP network in which computer networks are interconnected using Internet Protocol (IP) technology. Thus, network 120 may include closed domain networks. The closed domain networks may implement restrictions on both the number of users subscribing to the network and on the purposes for which the network may be used. A network modem/router 130 is connected illustratively to network 120 and to user terminal 140. Network modem/router 130 may modulate and demodulate digital and analog signals between network 120 and user terminal 140, and the Network modem/router 130 may connect or repeat signals (i.e., control routes) between different computer networks.

As shown in FIG. 1, delivery server 102 may include a portal server 110, a content server 112, a metadata server 114, and a DRM server 116. Content server 112, metadata server 114, and DRM server 116 may each be connected to portal server 110. Delivery server 102 is illustrated as including individual computer servers as portal server 110, content server 112, metadata server 114, and DRM server 116. However, delivery server 102 may be implemented as individual hardware devices performing the functions of portal server 110, content server 112, metadata server 114, and DRM server 116. Alternately, hardware devices or computers executing software may perform any combination of the functions of each server.

Portal server 110, content server 112, metadata server 114, and DRM server 116 may each include a central processing unit (“CPU”), a memory, a storage device such as a hard drive, an input/output interface, a communication interface, and a display, to provide server functionality. Since these components may be common to each of the servers, each component will be discussed once for all the servers involved.

A CPU (central processing unit) may function as an arithmetic processing and control unit executing computer programs to controlling the various components of each server. A memory may be implemented as a RAM (random access memory), a ROM (read only memory), and/or a cache memory. In operation, the memory may temporarily store the data or programs being operated on or carried out by the CPU. A storage device may be a hard disk drive (HDD) or a flash memory that stores data for an extended period of time. The storage device may store such data as user information, terminal performance information, network information, and computer programs.

An input/output (I/O) interface to each server may include a device such as a mouse, a keyboard, a touch-sensitive panel, buttons, switches and levers. Inputs and outputs may be implemented as input and output to and from the CPU. For example, the administrator of delivery server 102 may operate an IO device to input data and processing instructions to the various servers. A communication interface may include a communication line, a communication circuit, and a communication device. The communication interface allows data to be exchanged between the servers or between each server and user terminal 140 via computer network 120.

A display may be a device such as a liquid crystal display (LCD), a CRT display, or a lamp device for displaying video signals. The display may also include an audio output device such as speakers for outputting audio signals. For example, the administrator of delivery server 102 may verify the results of the operations carried out through the input/output interface by viewing output on the display.

Portal server 110 may provide user terminal 140 with navigation information about content items available from the content delivery service. Upon receipt of a request from user terminal 140, portal server 110 forwards data from user terminal 140 to content server 112, metadata server 114, or DRM server 116 depending on the request. Portal server 110 further receives data from content server 112, metadata server 114, or DRM server 116 and forwards the received data to user terminal 140 over network 120. The CPU of portal server 110 may implement a transmission function that transmits content items to user terminal 140. Alternately, the transmission function may be performed entirely or in part by hardware such as an FPGA or ASIC.

Content server 112 stores content items such as movies, songs, sports events, and software. In response to a request from user terminal 140, content server 112 transmits the requested content items to user terminal 140 through portal server 110.

When transmitting video contents such as movies or sports events, content server 112 may encode the target content items in MPEG-2, MPEG4, QuickTime, or another video format before transmitting the encoded content items to user terminal 140.

When transmitting audio content items such as songs, content server 112 may encode the content items in MP3 (MPEG-1 Audio Layer-3), ATRAC (Adaptive Transform Acoustic Coding) format, or another audio format before transmitting the encoded data to user terminal 140.

Content server 112 stores reproduction control metafiles that may be transmitted to user terminal 140. A reproduction control metafile may used by user terminal 140 when reproducing content items stored on user terminal 140. For example, a reproduction control metafile for a video content item may include chapter start points as well as time data indicating highlights in the content item.

Content server 112 stores series meta information files and sends the series meta information files to user terminal 140. A series meta information file is a kind of metadata and contains information about a series including a plurality of content items. For example, a series meta information file may include schedule information such as release dates of the content items in the series.

The CPU of content server 112 may implement a transmission function and a request reception function by executing software. Alternately, these functions may be performed entirely or in part by hardware such as a reprogrammable device such as an FPGA or ASIC. The transmission function transmits a plurality of content items and a series meta information file to user terminal 140. The request reception function receives a transmission request from user terminal 140 based on schedule information in the series meta information file. Upon receipt of the transmission request, the request reception function forwards the request to the transmission function. The transmission function then transmits the requested content items to user terminal 140.

Metadata server 114 stores metadata about content items and sends some of the metadata to user terminal 140. Generally, the metadata sent to user terminal 140 will correspond to content items requested by user terminal 140. The metadata may include such content-related data as title of the content items, dates of production, cast names, summaries, genres, and release dates.

DRM server 116 implements Digital Rights Management (“DRM”) for the content items to be delivered to user terminal 140. DRM server 116 receives, from user terminal 140, a request to issue a license for a content item of interest. If user terminal 140 is found to meet one or more preconditions for license issuance, then DRM server 116 issues the license to user terminal 140.

Generally, user terminal 140 may not reproduce content items downloaded from content server 112 without first acquiring an appropriate license. License issuance preconditions may include user conditions and other requirements. Digital rights management may be implemented various technologies, some of which may not include the license issuance process discussed above.

A license may include reproduction constraint information specifying constraints on the reproduction of the content item downloaded by user terminal 140. The reproduction constraints may include an allowed reproduction period, an allowed reproduction date, and an allowed reproduction count. The allowed reproduction period may be a predetermined period of time which starts on the day user terminal 140 receives the content item and during which user terminal 140 is allowed to reproduce the downloaded content item. The allowed reproduction date is a predetermined date on which user terminal 140 is allowed to reproduce the downloaded content item regardless of when the data in question was downloaded. The allowed reproduction count is a predetermined number of times user terminal 140 is allowed to reproduce the downloaded content item.

The CPU of DRM server 16 may implement a transmission function and a request reception function by executing software. Alternately, these functions may be performed entirely or in part by hardware such as an FPGA or ASIC. The transmission function transmits a license including reproduction constraint information to user terminal 140. The request reception function receives a reproduction constraint information transmission request sent by user terminal 140 based on user verification. Upon receipt of the license transmission request, the request reception function forwards the request to the transmission function, and the transmission function then transmits the requested license to user terminal 140.

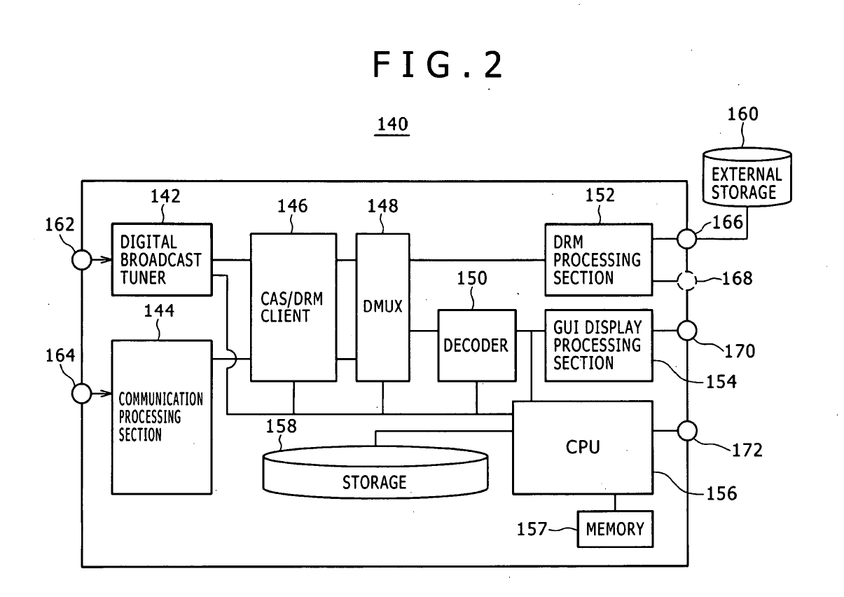

User terminal 140 is connected to network 120. For example, user terminal 140 may be a personal computer, a tuner incorporating a radio receiver or a TV set, a cable TV set, or a set-top box capable of receiving an IP broadcast through cable TV or other networks. As shown in FIG. 2, user terminal 140 may include a CPU 156, a memory 157, a storage device 158, and a communication interface 164.

User terminal 140 transmits a request for content items to portal server 110, for content to be downloaded over network 120. Through portal server 110, user terminal 140 receives the requested content items and a series meta information file from content server 112, metadata from metadata server 114, and a license from DRM server 116. User terminal 140 is connected to a display device 180. User terminal 140 may implement a display control function that controls display device 180 to display content items, series meta information, a GUI (graphic user interface), and an ECG (electronic content guide). The display control function may be implemented by a CPU in user terminal 140 by executing software. Alternately, the display function may be performed entirely or in part by hardware such as an FPGA or ASIC.

The GUI provides a display through which the user may easily interact with electronic books, video games, software and other items. Using metadata, the ECG provides the user with the capability of navigating through lists of content items downloadable from delivery server 102, lists of purchased content items reproducible on user terminal 140, and detailed information about individual content items. Based on schedule information in a series meta information file for a given series, the GUI displays a download schedule of the content items included in the series. Thus, the GUI allows the user to verify when desired content items will become available for download.

For example, display device 180 may be a computer terminal or a TV set. Display device 180 may be a liquid crystal display (LCD) device, a plasma display device or a CRT display device. Display device 180 may also include an audio signal output device such as speakers.

Display device 180 is connected to user terminal 140 and is controlled by the display function of user terminal 140. Display device 180 reproduces content-related video and audio signals and displays GUI and ECG screens based on data received from user terminal 140. User terminal 140 and display device 180 may interact using an interface such as HDMI (High-Definition Multimedia Interface) that allows video signals, audio signals, and control signals to be exchanged. User terminal 140 and display device 180 may be two independently structured devices or may be a single device integrating user terminal 140 with display device 180.

Display device 180 displays the reproduction constraints on the downloaded content items along with a list of purchased content items that may be viewed on user terminal 140. Display device 180 may further indicate whether the downloaded content items are currently reproducible based on the reproduction constraints. Before the reproduction constraints on a given content item take effect, display device 180 may prompt the user to purchase another license for the content. Display device 180 may also prompt the user to determine whether certain content items should be deleted from a storage device of user terminal 140 or moved from user terminal 140 to an external storage device. Furthermore, display device 180 may display a period during which each of the content items included in a given series may be downloaded.

A remote control 190 is capable of operating user terminal 140 from a distance. Using remote control 190, the user may control reproduction an AV player as well as a Broadcast Markup Language (“BML”) browser and ECG operations. Alternately, user terminal 140 may include an one or more integral control devices such as a keyboard, mouse, or touchpad.

FIG. 2 is a block diagram of user terminal 140. As shown in FIG. 2, user terminal 140 may include a digital broadcast tuner 142, a communication processing section 144, a Conditional Access System/Digital Rights Management (“CAS/DRM”) client 146, a demultiplexer (“DMUX”) 148, a decoder 150, a DRM processing section 152, and a graphical user interface (“GUI”) display processing section 154, each of which may be implemented as hardware or as software functions executed by CPU 156. User terminal 140 also includes storage device 158 which may store instructions for execution by CPU 156.

Digital broadcast tuner 162 receives digital broadcasts (broadcast satellite “BS”, communications satellite “CS”, and terrestrial TV channels) and outputs broadcasted data to the various elements of user terminal 140. Digital broadcast tuner 142 receives digital broadcast signals via an antenna line and a broadcast interface 162. When equipped with digital broadcast tuner 142, user terminal 140 may receive not only IP-based TV broadcasts but also TV broadcasts received via the antenna line. User terminal 140 may also be offered without digital broadcast tuner 142.

Communication processing section 144 controls communications in accordance with such protocols as Real-time Transport Protocol (“RTP”), User Datagram Protocol (“UDP”), HyperText Transfer Protocol over Transport Layer Security protocol (“HTTP/TLS”), Real-Time Streaming Protocol (“RTSP”), Transmission Control Protocol (“TCP”), Internet Protocol (“IP”), and Internet Group Management Protocol over Multicast Listener Discovery protocol (“IGMP/MLD”). Communication processing section 144 receives content items and other data through communication interface 164 (such as an Ethernet port) and outputs the received content items or other data to the various elements of user terminal 140. When using an unreliable protocol such as UDP for streaming data, communication processing section 144 minimizes jitter caused by network communications and carries out forward error correction (“FEC”) processing. CAS/DRM client 146 acquires licenses from a CAS server or from DRM server 116. CAS/DRM client 146 decrypts content items and other data received in encrypted form. CAS/DRM client 146 also manages digital broadcast of content items using CAS (Conditional Access System) and decrypts content items encrypted in DRM (Digital Rights Management) format. CAS/DRM client 146 may include a descrambler and a decrypter. On receiving content items from digital broadcast tuner 142 or communication processing section 144, CAS/DRM client 146 decrypts the content items and forwards the decrypted content items to DMUX 148.

DMUX 148 receives decrypted content items from CAS/DRM client 146 and demultiplexes the received content items into video data, audio data, subtitles, and Program Specific Information (“PSI”)/Service Information (“Si”).

Decoder 150 may include a video decoder for decoding video data, an audio decoder for decoding audio data, and a subtitle decoder for decoding subtitle data.

If the demultiplexed video and audio data are to be stored on an external storage device 160, DRM processing section 152 encrypts the video and audio data before sending the video and audio data to external storage device 160. Thus, the content items may be reproduced only on a user terminal authorized to reproduce the content items. If external storage device 160 is connected to an unauthorized user terminal, the unauthorized user terminal will not be able to reproduce the content items stored on external storage device 160.

Data encrypted by the DRM processing section 152 may be output to external storage device 160 through input/output interface 166 or to removable media through input/output interface 168. For example, external storage device 160 may be a hard drive or flash drive. Removable media may be a DVD or CD attached to an optical disk drive such as a CD drive or a DVD drive.

GUI display processing section 154 creates data that may be viewed by the user on display device 180. The data may be viewed after reproduction of the video signal decoded by the video decoder or after merging display-ready data from the browser, EPG and ECG. The data created by GUI display processing section 154 is output to display device 180 through a video/audio output interface 170.

CPU 156 functions as an arithmetic processing and control unit capable of controlling the processes of the components and functions of user terminal 140. CPU 156 controls various applications such as the browser, downloading of content items, storing of the downloaded content items on storage device 158, and reproduction of the content items stored on storage device 158.

CPU 156 of user terminal 140 may implement a number of functions by executing software. Alternately, these functions may be performed entirely or in part by hardware such as a reprogrammable device such as an FPGA or ASIC. Among the functions that may be executed by CPU 156 or hardware are a reception function, a display control function, a transmission request function, an update verification function, a metadata transmission request function, and a storage control function. The reception function receives content items and a series meta information file sent by content server 112 in delivery server 102. The reception function also receives a license sent by DRM server 116. The received license may include reproduction constraint information.

The display control function reproduces the content items on storage device 158 or external storage device 160 provided the reproduction constraint information in the license indicates that the content items may be reproduced. The transmission request function requests transmission of content items based on the schedule information in the series meta information file on storage device 158.

The update verification function compares a series meta information file stored in content server 112 with the corresponding series meta information file in storage device 158 of user terminal 140. The comparison is used to determine whether the series meta information file in content server 112 has been updated. For example, the update verification function compares version information as well as update dates between the serial meta information files. If the metadata has been updated, the update verification function requests transmission of the updated series meta information file.

The storage control function stores the content items, content meta information, and license meta information received by the reception function on storage device 158. The storage control function may also delete content items, content meta information, and/or license meta information from storage device 158. The storage control function may also move content items, content meta information, and/or license meta information from storage device 158 to external storage device 160. User terminal 140 may be connected with external storage device 160 using Ethernet, Universal Serial Bus (“USB”), or External Serial Advanced Technology Attachment (“eSATA”) interfaces in order to transfer data in a protected manner using a secure protocol such as Digital Transmission Content Protection over Internet Protocol (“DTCP/IP”).

Applications executed by CPU 156 may include a browser 174 and an AV player 176.

Browser 174 may be a BML (Broadcast Markup Language) browser, i.e. a program that reproduces information described in BML. Using BML makes it possible to define an object to display, when to display the object, and where on the screen of display device 180 the object should be displayed. BML also makes it possible to display links to related programs and Internet URLs, to describe titles and texts, and to define user interface controls such as operation buttons.

Browser 174 causes display device 180 to display a list of downloadable or other content items, thus allowing the user to select desired content items to be downloaded. Browser 174 also enables 10 to display a list of purchased content items, for example those in storage device 158, so that the user may select one of the content items to be reproduced.

AV player 176 performs processes for reproducing content items such as video or audio data. For example, AV player 176 may start and stop content item reproduction, fast-forward, rewind, and move between chapters.

Memory 157 may be, for example, a RAM (random access memory), a ROM (read only memory), or a cache memory. Thus, memory 157 may temporarily store data being operated on by CPU 156, or programs being executed by CPU 156.

Storage device 158 records downloaded content items through the download control and storage control functions of CPU 156. Storage device 158 may be a hard disk drive (HDD), a flash memory, or other nonvolatile storage device that stores data for an extended period of time.

Input/output interface 172 may include an operation section and an input control section. The operation section may include a mouse, a keyboard, a touch-sensitive panel, buttons, switches, and/or levers. The input control section creates input signals based on inputs to the operation section and outputs the created signals to CPU 156. Typically, the user may operate the operation section of the input/output interface 172 to input data to user terminal 140 or to give processing instructions to user terminal 140.

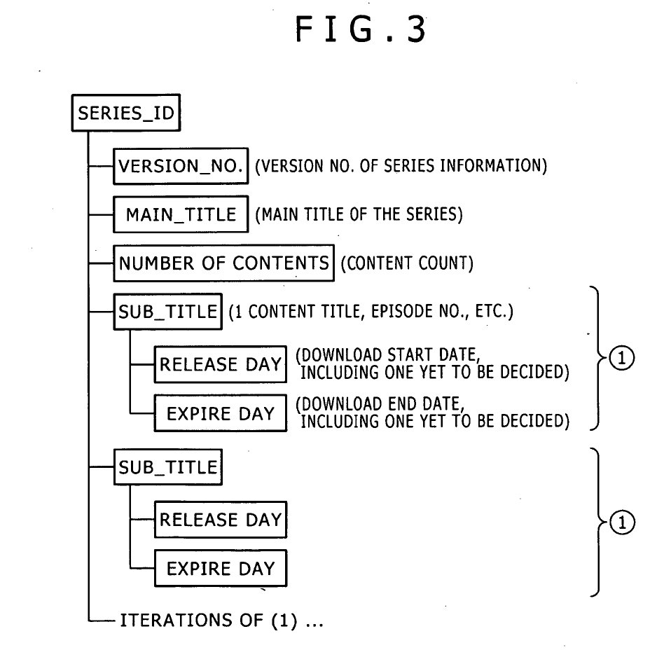

FIG. 3 illustrates an exemplary series meta information file 300.

A series may include a plurality of content items. For example, a series may be a serial drama including a plurality of episodes (content items) with the same main title. Alternatively, a series may include a plurality of content items associated with one another by having other common features, as expressed by the metadata. The common features may be, for example, persons (e.g., director, cast members, etc.) associated with each of the content items, a genre (e.g., drama, movie), a time period (e.g., time of production, period in which the drama, movie, etc., is set), or a location (e.g., location of production, location for shooting). A series may include multiple content items having any of these features in common.

A plurality of content items constituting each series may be stored in chronologically staggered order on content server 112. User terminal 140 requests transmission of content items based on the schedule information in the series meta information file 300, so that the user will not miss out on download start dates. Since there is no need to store all of the content items in a given series concurrently, the necessary storage capacity of content server 112 may be reduced. Furthermore, access to content server 112 by user terminals 140 may be handled in a dispersed manner to reduce network traffic.

Series meta information file 300 contains a series ID “series_id” 301 representative of one series, together with a version number “version_no” 302 of the series meta information file 300, a main_title “main_title” 303 of the series corresponding to the file, and a content count “number_of_contents” 304 indicating the number of content items in the series. Series meta information file also includes a plurality of content titles or episode numbers each stored as a “sub_title” 305. Each sub_title 305 corresponds to a content item in the series. Sub_titles 305 include the title of the individual content items in the series, as well as a download start date “release_day 306” and download end date “expiration_day 307” for each of the content items in the series. The download start date and download end date may be left blank or include data indicating they are inapplicable to a particular content item.

Series meta information file 300 may be updated by delivery server 102. User terminal 140 checks to determine whether series meta information file 300 has been updated. If so, user terminal 140 receives the newly updated version of series meta information file 300. Thus user terminal 140 may receive the content items in a particular series based on the new schedule information. For example, a user might download a series meta information file 300 for a series at the same time as the user downloads a content item or items for the first episode of the series. The initially downloaded series meta information file 300 may leave download start dates or download end dates for content items corresponding to subsequent episodes undetermined. User terminal 140 may later receive an updated series meta information file 300 to acquire the subsequently determined download start/end dates so that all content items included in the series may be downloaded on time.

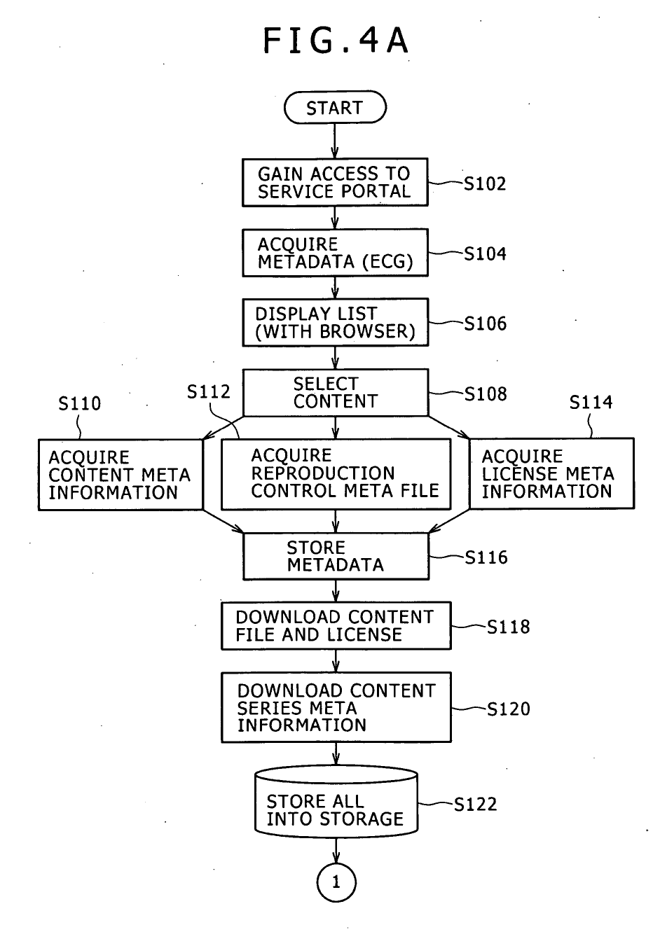

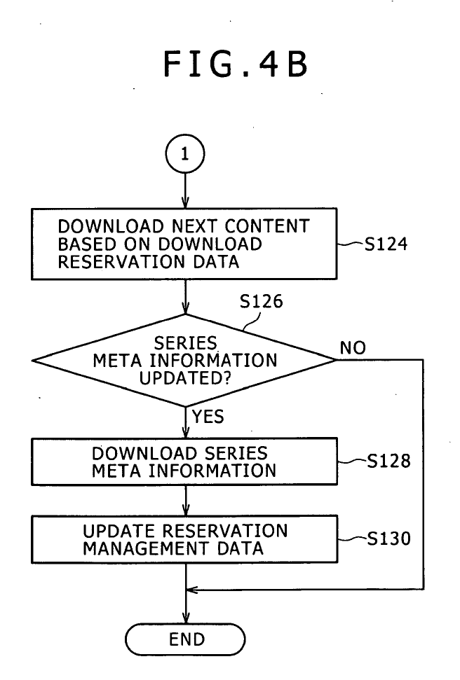

FIGS. 4A and 4B are flowcharts of methods performed by content delivery system 100.

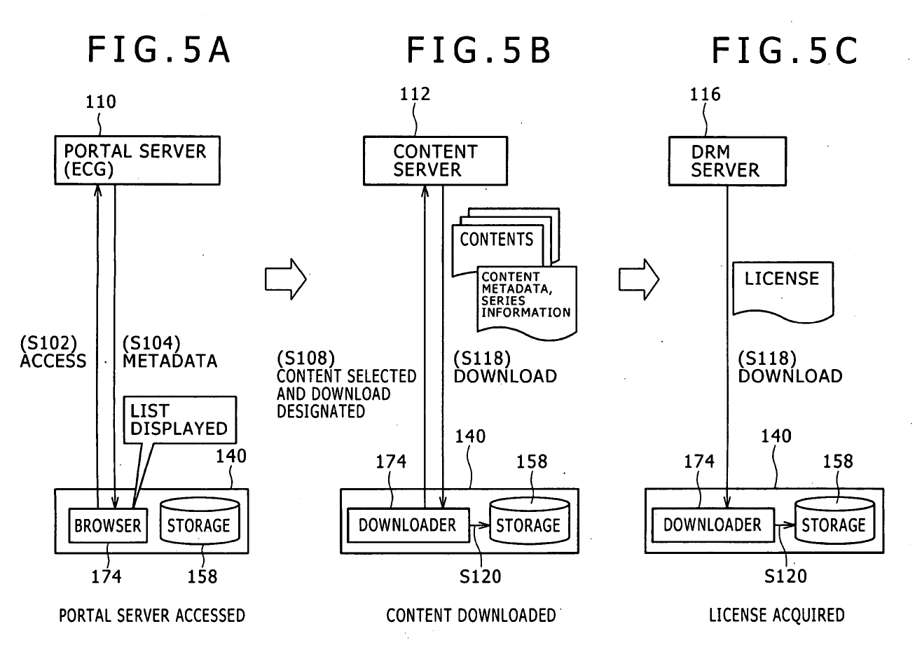

A user of, content delivery system 100 may perform operations to have user terminal 140 access delivery server 102. In step S102, user terminal 140 connects to portal server 110. In step S104, user terminal 140, authenticated by portal server 110, acquires metadata such as ECG-related data (e.g., a list of titles of downloadable content items) from portal server 110. Steps S102 and S104 are illustrated in FIG. 5A.

In step S106, browser 174 on user terminal 140 may display a content title list based on the acquired list of content items on display device 180. The displayed list allows the user to select preferred content items. Step S106 is illustrated in FIG. 5A.

In step S108, the user selects the desired content items to be downloaded and issues a content item download instruction to user terminal 140. Step S108 is illustrated in FIG. 5B.

Based on the download instruction from the user, user terminal 140 accesses content server 112, metadata server 114, and DRM server 116 by way of portal server 110. User terminal 140 acquires content meta information from metadata server 114 in step S110, a reproduction control metafile from content server 112 in step S112, and license meta information from DRM server 116 in step S114.

In step S116, user terminal 140 performs storage control processing on the acquired reproduction control metafile to store the reproduction control metafile into the storage device 158. After requesting content items from content server 112, user terminal 140 downloads the content items included in a given series from content server 112 and a license from DRM server 116 in step S118. Step S118 is illustrated in FIGS. 5B and 5C.

In step S120, user terminal 140 downloads the series meta information file 300 corresponding to the series from content server 112. Step S120 is shown in FIG. 5B.

In step S122, user terminal 140 stores the received content items, license, and series meta information file 300 in storage device 158. Once the content items have been stored in storage device 158, the content items may be retrieved and reproduced if the conditions attached to the license are met. Step S122 is shown in FIGS. 5B and 5C.

Because user terminal 140 has the series meta information file 300, user terminal 140 may manage the download schedule of the plurality of content items in a given series. For example, user terminal 140 may cause the display to display the periods during which the multiple content items may be downloaded. Thus, the display may prompt the user to determine when to download each content item. Alternatively, user terminal 140 may automatically send a content transmission request to the delivery server 102 when a particular content item becomes available for download.

In step S124 as shown in FIG. 4B, user terminal 140 downloads the next content item available for download based on the schedule information in the series meta information file 300. In step S126, the update verification function of user terminal 140 checks to determine whether the corresponding series meta information file 300 stored by content server 112 has been updated. If the file has been updated, the metadata transmission request function of user terminal 140 requests transmission of and downloads the updated series meta information file 300 in step S128. In step S130, user terminal 140 places the updated series meta information file 300 into storage device 158. Thereafter, the download schedule of the multiple content items constituting the series is managed on the basis of the updated series meta information file 300.

If the series meta information file 300 is not updated in content server 112, then user terminal 140 manages the download schedule of the subsequent content items in accordance with the currently stored series meta information file 300.

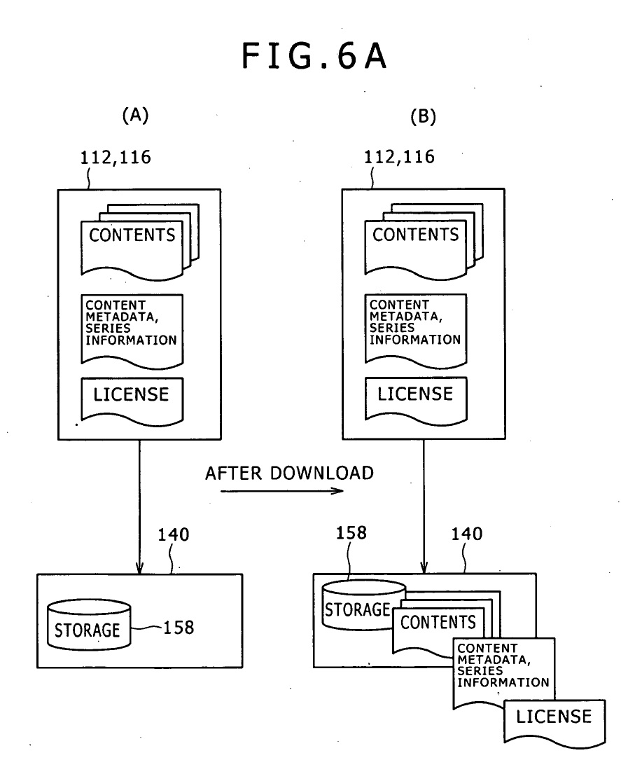

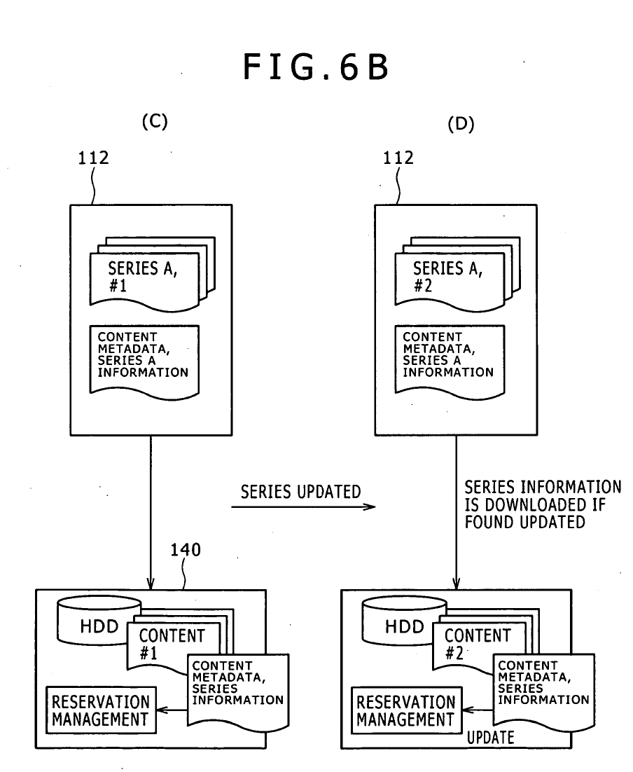

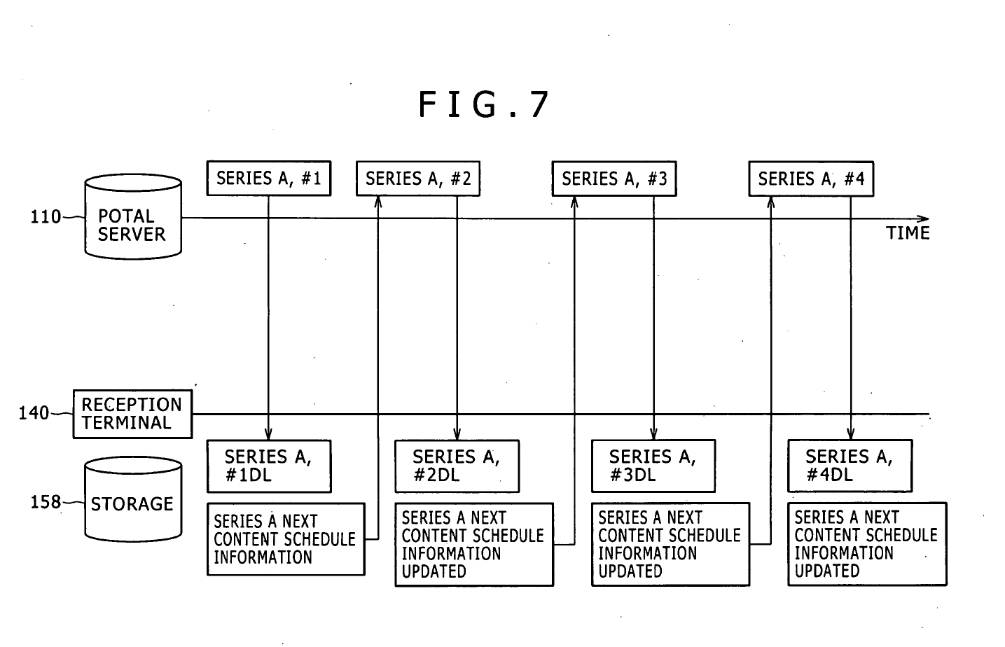

FIGS. 6A, 6B and 7 illustrate content management embodiments by the content delivery system 100.

FIGS. 6A and 6B illustrate chronological views of content delivery system 100. As shown in view 600A, before user terminal 140 downloads content items or other data, storage device 158 of user terminal 140 has no record of reproducible content items. Following a content transmission request to delivery server 102, user terminal 140 downloads content items and a corresponding series meta information file 300 from content server 112 and license meta information from DRM server 116. Thereafter, as shown in view 600B, storage device 158 of user terminal 140 includes the content items, series meta information file 300, and license. User terminal 140 may then reproduce the content items as long as the reproduction constraints of the license are met.

As shown by view 600C of FIG. 6B and FIG. 7, schedule management may be conducted based on series meta information file 300. Assuming a plurality of content items are included in a series A, and the first content item 601 in the series is downloaded. The corresponding series meta information file 300 is downloaded at the same time as first content item 601. Based on the downloaded series meta information file 300, user terminal 140 manages the download schedule of subsequent content items. When the downloadable period starts for the next content item in the series, user terminal 140 downloads the next content item, for example second content item 602 as illustrated in FIG. 6B.

When downloading a new content item, user terminal 140 checks to determine whether the corresponding series meta information file 300 in content server 112 has been updated. If series meta information file 300 is found to have been updated, e.g., if version_no 302 of series meta information file 300 is found to be updated, then user terminal 140 sends a series meta information file transmission request to content server 112, and downloads updated series meta information file 300. Thereafter, user terminal 140 may effect schedule content item downloads based on the updated series meta information file 300.

User terminal 140 continues to download subsequent content items included in series A. For example, as shown in FIG. 7, user terminal 140 successively downloads third content item 603, fourth content item 604, etc., of the series A. The downloads proceed in accordance with the schedule information in series meta information file 300. Upon downloading each content item, user terminal 140 verifies whether the corresponding series meta information file 300 has been updated. If the file is found to have been updated, user terminal 140 downloads the updated series meta information file 300.

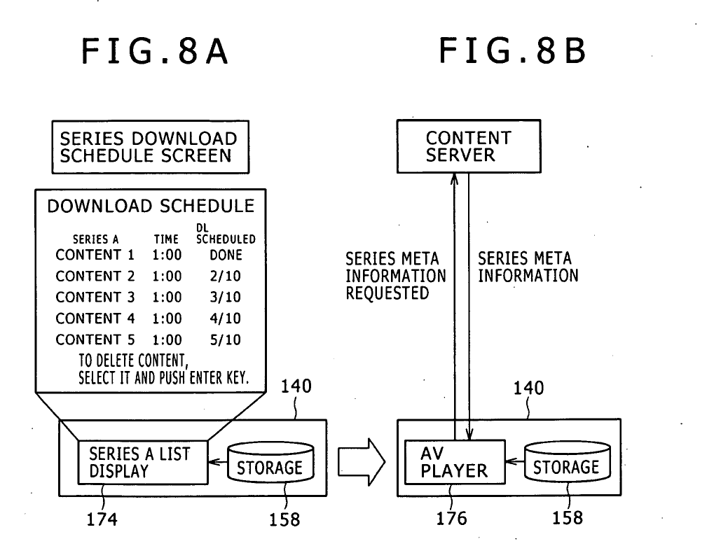

As shown in FIG. 8A, browser 174 causes a plurality of content items included in series A to be displayed in accordance with the schedule information in the series meta information file 300. FIG. 8A illustrates a GUI 800 of a schedule screen for series A. For example, in FIG. 8A, first content item 601 through fifth content item 605 included in series A are displayed. GUI 800 presents the content download schedule for series A to the user. The user may delete the indication of a downloaded content item by selecting the content item on the GUI 800.

FIG. 8B illustrates content delivery system 100 upon download of the next content item, for example second content item 602. User terminal 140 concurrently sends a series meta information file transmission request by way of the DRM client of AV player 176. If series meta information file 300 has been updated, user terminal 140 downloads updated series meta information file 300.

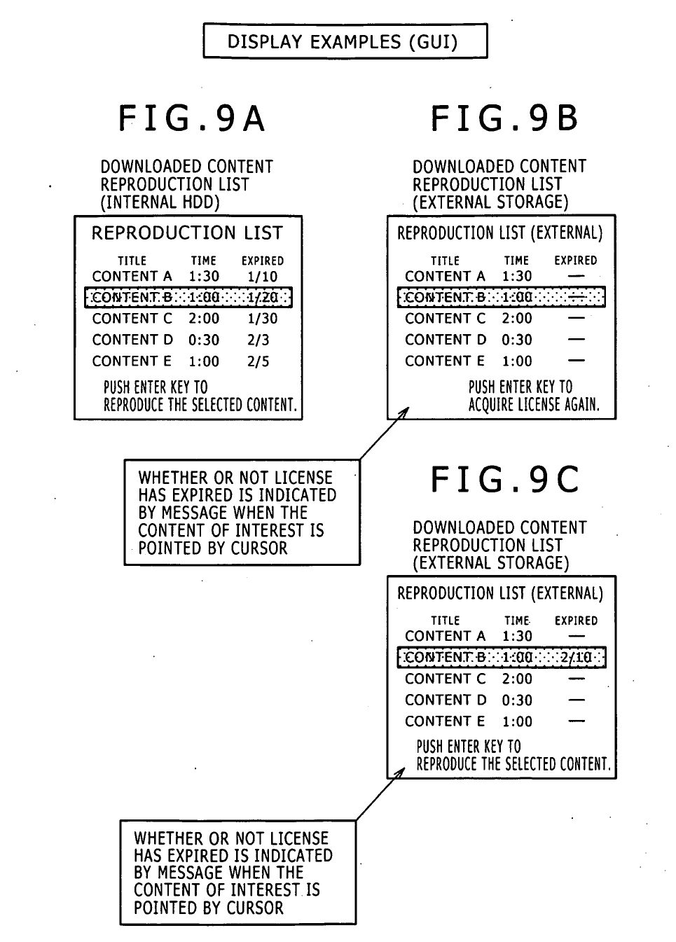

FIGS. 9A, 9B, and 9C illustrate windows displayed by display device 180 of user terminal 140.

FIGS. 9A, 9B, and 9C each display titles of downloaded content items displayed in different windows. FIG. 9A indicates a reproduction list 900A of content items stored in storage device 158 (e.g., an internal hard disk drive) of user terminal 140.

As shown in FIG. 9A, content items A 901 through E 905 are displayed in reproduction list 900A using their titles, reproduction times, and expiration dates (months, days) according to their respective licenses. A desired content item may be selected by moving a cursor on the screen to highlight a content item, for example content item B 902. If a given content item with an effective license is selected, a message 906 “PUSH ENTER KEY TO REPRODUCE THE SELECTED CONTENT” may be displayed the bottom of the screen. Pushing the enter key then causes the selected content item to be reproduced.

FIGS. 9B and 9C illustrate exemplary lists of content items stored by external storage device 160. As shown by reproduction list 900B in FIG. 9B, a desired content item may be selected by moving the cursor to highlight a content item such as content item B 902. If a selected content item does not have an effective license (e.g., the license has expired), a message 907 “PUSH ENTER KEY TO ACQUIRE LICENSE AGAIN” may be displayed at the bottom of the screen, thus prompting the user to obtain the license again. If a content item with a reacquired license is selected using the cursor, the expiration date of the reacquired license is indicated in reproduction list 900C, as shown in FIG. 9C. When the content item corresponding to the reacquired license is selected using the cursor, a message 908 “PUSH ENTER KEY TO REPRODUCE THE SELECTED CONTENT” may be displayed at the bottom of the screen. Pushing the enter key then causes the selected content item to be reproduced.

Each of the steps performed by content delivery system 100 can be stored as instructions on a computer-readable medium. A computer-readable medium can be magnetic storage, optical storage, solid state storage, a hard drive, RAM, ROM, CD, DVD, flash drive, or other device suitable for storing computer-readable instructions. The system may be implemented by one or more of the CPUs executing the instructions stored on the computer-readable medium.

It is to be understood that while the invention has been described in conjunction with specific embodiments and with reference to the accompanying drawings, many alternatives, modifications and variations will become apparent to those skilled in the art in light of the foregoing description. Accordingly, it is intended that the present invention embrace all such alternatives, modifications and variations as fall within the spirit and scope of the appended claims.

For example, in the foregoing description, checking of whether or not the series meta information file 300 has been updated was described as being performed concurrently with downloading content items. If updates to series meta information file 300 are detected, the file file is downloaded. However, the present invention includes alternative implementations. For example, checking for updates to, and downloading, series meta information file 300 may occur at other times besides when content items are being downloaded. Further, a processor may be implemented either as a central processing unit (“CPU”) or by reconfigurable hardware such as an FPGA or ASIC.

The scope of the invention should be determined by the appended claims and their legal equivalents, rather than by the examples provided in the foregoing description.

What is claimed is:

1. A system comprising:
a delivery server comprising a processor; and
a user terminal comprising a processor,
wherein the delivery server processor is configured to:
transmit metadata including schedule information about release dates for content items;
receive a request for one of the content items, the request being based on the schedule information included in the metadata; and
transmit the requested content item in response to the request, and
wherein the user terminal processor is configured to:
receive the metadata including the schedule information about release dates for the content items;
send the request for one of the content items based on the schedule information included in the metadata; and
receive the requested content item.

2. A delivery server comprising a processor configured to:
transmit metadata including schedule information about release dates for content items;
receive a request for one of the content items, the request being based on the schedule information included in the metadata; and
transmit the requested content item in response to the request.

3. The delivery server according to claim 2, wherein at least one of a title, an individual, a genre, a time, or a place is common to the content items.

4. The delivery server according to claim 2, further comprising a database configured to store the content items;
wherein the content items stored in the database are replaced based on the release dates of the content items.

5. The delivery server according to claim 2, wherein the metadata includes at least one of a main title of a series, a number of content items in the series, and a subtitle for the content items in the series.

6. The delivery server according to claim 2, wherein the metadata further includes an expiration date for the content items.

7. The delivery server according to claim 2, wherein the metadata is updated to reflect new release dates for the content items.

8. The delivery server according to claim 5, wherein updated metadata is transmitted in response to a request made by a user terminal for transmission of the updated metadata.

9. A user terminal comprising a processor configured to:
receive metadata including schedule information about release dates for content items;
send a request for one of the content items based on the schedule information included in the metadata; and
receive the requested content item.

10. The user terminal according to claim 7, wherein at least one of a title, an individual, a genre, a time, or a place is common to the content items.

11. The user terminal according to claim 7, further comprising a display for displaying the schedule information included in the metadata.

12. The user terminal according to claim 9, wherein the metadata includes at least one of a main title of a series, a number of content items in the series; and a subtitle for the content items in the series.

13. The reception apparatus according to claim 9, wherein the metadata further includes an expiration date for the content items.

14. The user terminal according to claim 7, wherein the metadata is updated to reflect new release dates for the content items.

15. The user terminal according to claim 10, further comprising a storage device to store the received metadata;
wherein the processor is further configured to:
verify whether the metadata has been updated by the delivery server by comparing metadata stored in the delivery server with the metadata stored in the storage device; and
request transmission of the updated metadata if the metadata has been updated;
wherein the storage device stores the updated metadata.

16. A computer-readable medium containing processor readable instructions for causing a computer to execute a method, the method comprising:
transmitting metadata including schedule information about release dates for content items;
receiving a request for one of the content items, the request being based on the schedule information included in the metadata; and
transmitting the requested content item in response to the request.

17. A computer-readable medium containing processor readable instructions for causing a computer to execute a method, the method comprising:
receiving metadata including schedule information about release dates for content items;
sending a request for one of the content items based on the schedule information included in the metadata; and
receiving the requested content item.

18. A computer-implemented method comprising:
transmitting metadata including schedule information about release dates for content items;
receiving a request for one of the content items, the request being based on the schedule information included in the metadata; and
transmitting the requested content item in response to the request.

19. A computer-implemented method comprising:
receiving metadata including schedule information about release dates for content items;
sending a request for one of the content items based on the schedule information included in the metadata; and
receiving the requested content item.
